(19) United States
(12) Patent Application Publication
(10) Pub. No.: US 2012/0166400 A1
(43) Pub. Date: Jun. 28, 2012

(54) TECHNIQUES FOR PROCESSING OPERATIONS ON COLUMN PARTITIONS IN A DATABASE

(75) Inventors: Paul Sinclair, Manhattan Beach, CA (US); Donald R. Pederson, San Diego, CA (US)

(73) Assignee: Teradata US, Inc., Dayton, OH (US)

(21) Appl. No.: 12/979,526

(22) Filed: Dec. 28, 2010

(51) Int. Cl. G06F 17/30

(52) U.S. Cl. 707/692; 707/E17.005

(57) ABSTRACT

Techniques for processing operations on column partitions of a table in a database are provided. A table includes a control column partition. Each delete container of the control column partition representing multiple rows in the table (or a row partition, if any), and each row represented by a bit flag within a bit string. Rows of the table set for deletion have their corresponding bits within a particular delete container set to indicate those rows are deleted.

### BACKGROUND

In large commercial database systems it is often beneficial to partition the table of a database into smaller tables or segments, such that each smaller table or segment is capable of being individually accessed within a processing node. This promotes reduced input and output when only a subset of the partitions is referenced and improves overall database performance.

A popular approach to segmenting databases is referred to as row (or horizontal) partitioning. Here, rows of a database are assigned to a processing node (by hashing or randomly) are partitioned into segments within that processing node of the database system.

Another approach is to group columns together into segments (referred to as column or vertical partitioning), where each group of columns for rows assigned to a processing node are partitioned into segments within that processing node of the database system.

Both row and column partitioning have advantages to improving overall database performance.

One issue associated with column partitioning is deleting a row when each column group of the row is stored in a separate segment and multiple column values of the table (or row partition) are packed together in containers with implied row identifiers for other than the first value in the container (the header for the container includes the rowid for the first value) where each container is limited to a predefined maximum size that is less than the data block size for the database system. In such a situation, using one method would be to read and write a container for each column group and mark the column values for the row to be deleted. This increases the size of all containers to allow for a bit for each value to indicate whether its row is deleted or not. Often a column partitioned table has few deletes done against it but this first method increases the size of the table relative to all rows in the table, not just for the deleted rows. Another method is to split the container increasing the number of row identifiers and container overhead but this requires reading a container and writing two containers for each column group.

In addition, conventional column-storage approaches suffer from utilizing too much space for partitions that are nonempty. All of which impact space utilization and processing performance of database systems.

Therefore, improved techniques for processing operations on column-partitioned database systems are needed.

### SUMMARY

In various embodiments, techniques for processing operations on column partitions in a database are presented. According to an embodiment, a method for handling operations on column partitions of a database is provided.

Specifically, a row identifier is received for a row that is to be deleted within a table of a database. Assurance is made that the row identifier is represented within a control (delete) column partition associated with the table. Next, a bit flag for the row is set within the control column partition to indicate that the row is deleted from the table.

### BRIEF DESCRIPTION OF THE DRAWINGS

FIG. 1 is a diagram of a method for handling operations on column partitions of a database, according to an example embodiment.

FIG. 2 is a diagram of another method for handling operations on column partitions of a database, according to an example embodiment.

FIG. 3 is a diagram of a column partitioning processing system, according to an example embodiment.

### DETAILED DESCRIPTION

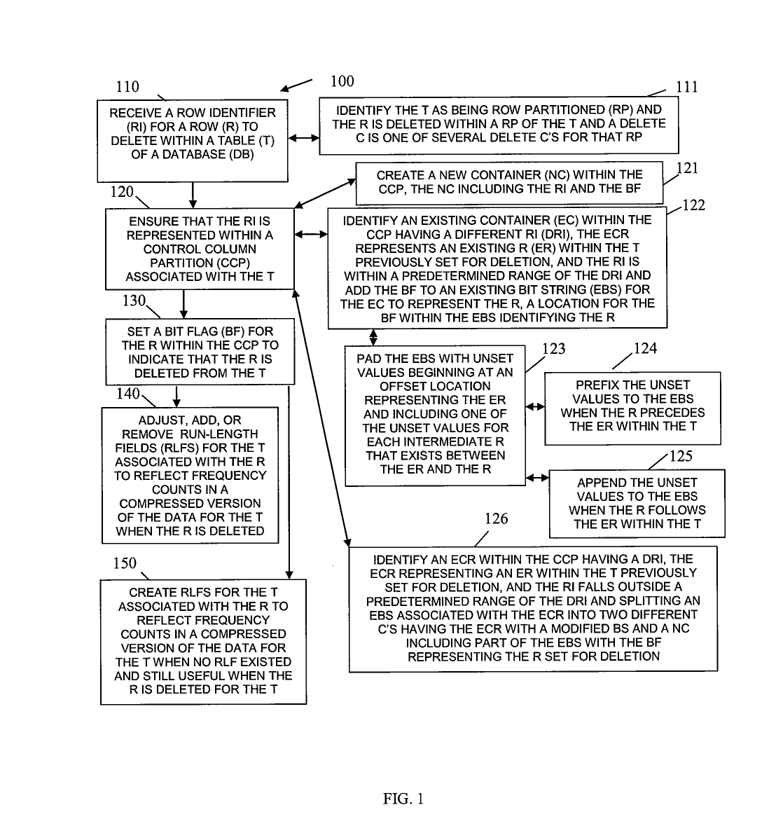

FIG. 1 is a diagram of a method 100 for handling operations on column partitions of a table in the database, according to an example embodiment. The method 200 (hereinafter “column partition manager”) is implemented as instructions within a computer-readable storage medium that execute on a plurality of processors, the processors specifically configured to execute the column partition manager. Moreover, the column partition manager is programmed within a non-transitory computer-readable storage medium. The column partition manager may also be operational over a network; the network is wired, wireless, or a combination of wired and wireless.

Before discussing the processing associated with the column partition manager some details regarding embodiments of the invention and context are presented, according to various embodiments described herein and below with reference to the FIGS. 1-3.

As used herein, a “fast path whole row partition delete” (sometimes referred to as a “deferred delete”) deletes all containers for specified row partitions for each of the column partitions including the control column partition. Note that if all the partitions are specified to be deleted or there is a DELETE ALL for the table, the table is emptied and, thereby, the delete column partition is also emptied.

The techniques described herein utilize a column partitioning approach that minimizes and reduces traditional issues associated with implementation and maintenance problems by having one or more delete bits (control bits) for each row in a control (delete) column to indicate logical deletes of a row to maintain a sequential order for implied row identifiers (rowids) within containers. This may be used in conjunction with row partitioning.

In one possible approach, when delete bits are used for each column, a delete of a row sets the delete bit to 1 for each column value of the deleted row. When the delete bit corresponding to a rowid is set to 1, a non-null, non-value-compressed column value is removed from the container (for a null or value-compressed value, there is no column value explicitly stored). This allows reading a container to find column values that are not included (because the associated logical row has been deleted) and properly determine the column value corresponding to a specific rowid.

In addition for a deleted row, storage is reduced if the column value is a non-null, non-value-compressed value. One issue with this conventional approach is that these bits are included in every column for every row thereby increasing the amount of storage needed. Also, to delete a logical row, a container for each column has to be read, updated, and written back to disk. Moreover, the logical row or a log of each modified container must be included in the transient journal (log used to track changes before a commit is made to the database).

An alternative to these pitfalls is proposed herein where an additional internal control column (such as column partition 1 for example) is used to indicate the logically deleted rows. This has the advantage of using only 1 delete bit for each logical row instead of 1 bit for every column value of each logical row. Also, a delete of a row only needs to update the control (delete) column to set the delete bit to 1 to indicate a deleted row. Moreover, the transient journal only needs to include the one modified delete container or the rowid for a logical row (and not the row itself or multiple containers).

However, even with this proposed approach a downside still exists such that, when processing a container to determine whether a column value is for a deleted row or not, the corresponding delete container of the control column must also be read (using up a file context). Another downside is that non-null, non-compressed values for the deleted row are not removed from the containers for the non-control column partitions. However, if there is a presence bit, value-compression bits for this container, or the values are variable length, this can still be done whenever the container for a column is updated but sometimes rows are not updated or rarely updated; to handle this, a pack utility, explicitly invoked or running in background, can be used to sweep the columns removing unnecessary column values from containers.

Yet, in many cases, a column partitioned table may be read-only, rarely have rows deleted, or rows are deleted in whole row partitions. The techniques provided herein describe improvements to the control column and how the control column is handled to improve the efficiency of reading data from the columns for these cases while still allowing other cases where deletes occur.

Specifically, to improve compression of the delete bits using run lengths (frequency counts for recurring values in compressed data), the delete bits are stored in their own column partition (the delete column partition, also noted here as column partition 1) with bits packed into containers (in this case, referred to as delete containers). If there are other control values, they can be stored in a separate column partition (or multiple separate column partitions).

When a column-partitioned table is created, it is initially empty and, moreover, the corresponding delete column partition is empty. Therefore, if the table is used only for read, there is no additional space used for indicating deletions until rows are actually deleted.

### Delete Processing Approach

When a logical row of column partitioned (CP) table is deleted but not as part of a fast path whole row partition delete, delete processing for the logical row is done as follows (assuming the rowid of the row to delete has been determined either from scanning the table to find a row to be deleted or from an index):

1) If there are no containers in the delete column partition corresponding to the row partition and hash bucket (indicator of the processing node that was assigned the row) of the rowid of the deleted row, then a delete container is built with the rowid of the deleted row as the starting rowid for the delete container and with one delete bit, which is set to 1.

2) Otherwise, if there is a delete container that includes the rowid of the deleted row, the corresponding delete bit for the deleted row is set to 1. The delete container may have been compressed using run lengths so this may involve adjusting run lengths, adding run lengths, or no longer using run length compression for this container if it is no longer effective in reducing the size of the container. If the delete container was not run-length compressed, then the container is run-length compressed if it would effectively reduce the size of the container.

3) Otherwise, if there is a delete container with a lower last rowid (but with the same row partition and hash bucket) than the rowid of the deleted row, the container is extended with 0 bits as needed up to the corresponding delete bit for the deleted row, which is set to 1 as long as the container does not exceed container size limits. The container may have been compressed using run lengths so this may involve adjusting run lengths. If the container was not run-length compressed, the container is compressed using run-length compression if it would effectively reduce the size of the container. Note that if the delete container exceeds container size limits, then the container is split into two containers (any leading and trailing 0 bits are removed from these two containers and the rowid for the each container is adjusted to correspond to the first delete bit in that container, as needed).

4) Otherwise, if there is a delete container with a higher starting rowid (but with the same row partition and hash bucket) than the rowid of the deleted row, the container is extended with 0 bits as needed backwards to the corresponding delete bit for the deleted row, which is set to 1 as long as the container does not exceed container size limits. The starting rowid for the container is set to the deleted row's rowid. The container may have been compressed using run lengths so this may involve adjusting run lengths. If the container is not run-length compressed, the container is run-length compressed if it effectively reduces the size of the container. Note that if the container exceeds container size limits, the container is split into two containers (any leading and trailing 0 bits are removed from these two containers and the rowid for the each container is adjusted to correspond to the first delete bit in that container, as needed).

5) Otherwise, split either the lower container, the higher container, or start a new container based on the size of these containers (at least one is found if not both). If a container is split, any leading and trailing 0 bits are removed from the two containers coming from the split and the rowid for the each of the containers is adjusted to correspond to the first delete bit in that container, as needed; then, extend the second container from the split if the lower container was split or the first container from the split if the higher container was split as described above in 3 or 4, respectively. If a new container is started, then build the new container as described above in 1.

Also, when a row is deleted but not as part of a fast path whole row partition delete, only the change to the delete column partition needs to be recorded in the transient journal (that is, just before image of the delete container or the rowid but not the image of the entire logical row). To roll back the delete, the delete container row is set back to its before image or the corresponding delete bit for the rowid is set to 0 in the delete column.

Note also that when the table is empty and rows are subsequently inserted (and possibly later updated), the delete partition remains empty as long as no deletes occurs.

Insert and Update Processing (Including Inserts and Updates for a Merge Statement):

It is noted that with the above described technique there is no special processing that is required.

Select Processing (Including Selecting Rows for Delete or Update Operations):

The delete column is used as follows for qualifying rows:

1) Check if the delete column partition is empty. If it is empty, the file context (current data block being processed) can be closed and no delete bit processing is needed to handle deleted rows because no rows have been deleted since the last time the table was empty.

2) Otherwise, when scanning a row partition for a column, if the corresponding row partition of the delete column is empty, no delete bit processing is needed for the row partition.

3) Otherwise, when scanning a container for a column (referred to as the select container), if the corresponding delete container that overlap this select container, if any, specify only 0 delete bits for the corresponding rowids associated with the values in the select container, no delete bit processing is needed for this select container.

4) Otherwise, delete bits are checked in the overlapping delete containers when scanning for a value or finding a value for a rowid; if the delete bit corresponding to a column value is 1, the value is skipped. If there is a portion of the select container not covered by the overlapping delete containers, the column values for that portion can be considered to be not associated with deleted rows.

### Sweep Utility Processing

A sweep utility is modified to also delete values from the beginning and end of delete containers that correspond to a delete bit set to 1 and the rowid adjusted for the delete container. Delete containers can be split to facilitate this trimming if the net result reduces the size of the column partition; splitting a container adds an additional container header (which includes the rowid of the first value in the container) so, unless the values removed are smaller than header, it not worth splitting a container). Delete containers can be trimmed also when all the corresponding column values have been trimmed (again, the container can be split to facilitate this trimming if the net result reduces the size of the column partition).

The approaches discussed above and below have provide novel benefits to conventional approaches, such that if no deletes have occurred since the table was empty, the delete column partition remains empty (saving disk space). Also, if the delete column partition is empty, the file context for reading the delete column partition can be closed (freeing up a file context) and other column partitions can be read without further checking the delete column partition. For example, if inserts are done to populate the table, and subsequently the table is used as a read only table until the data is no longer needed and the table is dropped or all the data deleted, the delete column partition is not used (and is empty taking up no disk space) other than to check once if it is empty for an operation on the table. Note also there is no need to declare the table as read only (it is read only based on its usage).

Moreover, if the delete column partition is not empty (there have been some deletes that created delete containers), the approaches discussed herein above and below minimize the size of the delete column partition and the checking of the delete column partition while scanning another column partition.

The techniques herein and below provide for efficient deletes using smaller transient journal entries while avoiding much of the column scanning and column value locating overhead of a fully-populated delete column partition when deletes have not occurred (and minimizes the size of the delete column partition when deletes have occurred).

In addition, the techniques provide for: 1) access reads that see the whole row or none of the row, if the columns partitions where physically removed then an access reader would see some columns there and some columns deleted; and 2) index access to the table does not need to check the deletion column partition, since the rowid from the index will look at valid data, if the row had been deleted then values would have been removed from the index.

It is with this initial discussion of the approaches described herein that the processing associated with the FIGS. 1-3 is now discussed.

It is noted that the column partition manager can be distributed to multiple processing nodes, such that each processing instance of the column partition manager is associated with managing one or more partitions of a database. Moreover, the database can include both row and column partitioning, in the manners discussed above.

Accordingly at 110, the column partition manager receives a row identifier for a row to delete within a table (or row partition) of a database. Receipt can occur via scanning the column partitions for which conditions are specified to find rows qualifying for delete or via an index in which the row identifier is provided along with an indication to delete the row associated with the row identifier.

In an embodiment, at 111, the column partition manager identifies the table as being row partitioned and the row is deleted within a row partition of the table and a delete container is one of several delete containers for that row partition.

At 120, the column partition manager ensures that the row identifier is properly accounted for within the delete column partition being maintained for the table. The column partition manager dynamically provides this representation within the delete column partition. The mechanisms for achieving this were discussed above.

For example, at 121, the column partition manager creates a new container within the delete column partition that includes one container (assuming the row being deleted is a first row being identified as set for deletion within the partition). The container includes a container header (which indicates the row identifier for the first bit flag in the container) and a bit flag. The bit flag indicates whether the row is to be deleted or not deleted. Deletion is indicated when the bit flag is set and no deletion is noted when the bit flag is unset.

In another case, at 122, and where the delete column partition is nonempty, the column partition manager identifies an existing delete container within the delete column partition having a different row identifier. The existing delete container represents an existing row within the partition that was previously set for deletion. Here, the row identifier for the row is identified as falling within a predetermined range of the different row identifier (predetermined length for a bit string having the bit flag for the row and other bit flags for other rows of the partition). In other words, the existing container includes a key for the different row identifier but the row identifier being processed falls within a range of rows that the existing container is set to represent and handle.

If the rowid is between the first rowid of the container (the one in the container header) and the implied rowid for the last bit in the container, the unset bit corresponding to the rowid of the row to be deleted is set.

Continuing with the embodiment of 122 and at 123, if the row identifier of the row to be deleted is higher than the last rowid currently covered by the delete container, the column partition manager pads the existing bit string with unset values up to the offset location for the bit of the row to be deleted and then sets bit is added for that rowid.

Still continuing with the embodiment of 123 and at 124, when the row precedes the existing row indicated for the rowid in the delete container header, the column partition manager prefixes unset values to the existing bit string as needed to get to the location of the bit for the rowid of the row to be deleted, prefixes a set bit, and replaces the rowid in the container header with the rowid of the row that is being deleted.

So for the processing associated with 120-125 consider the following example (presented for purposes of illustration only). Suppose initially the delete column partition is empty when a row identified by the number 100 is received and requested to be deleted from the table. Here, initially the delete column partition is empty (no delete containers) before the row for row identifier 100 is deleted and once deleted the delete column partition appears as follows with a single delete container: “header(100),1”, where 100 is the row identifier and 1 is the bit flag set (indicating the row is to be deleted from the table). Notice that the delete column partition and any existing delete containers dynamically grow as needed (maximizing space utilization). Now suppose, instead, that the delete column partition has one delete container appearing as: “header(99),1”; here, row 99 is set for deletion where the first bit set in the bit string “1” corresponds to the row identifier 99 (for row 99). Now, suppose the row identifier is row 104 that is to be set for deletion. The container appears now as “header(99),100001”, because to get to 104 to set the bit flag for 104 there are 4 intermediate rows to represent for rows 100, 101, 102, and 103 (that aren't deleted). Using run length compression, the container would be “header(99),(1)1,(4)1,(1)1”. Thus, the existing delete container's existing bit string was padded with 4 unset bit flags (0's) and 1 set bit. Similarly, unset bits can be prefixed onto a delete container for a row being deleted that appears before the row identifier for the container within the delete column partition. For example, if row 96 is to be deleted, the container is changed to “header(96),100100001”. And then if row 102 is to be deleted, the container is changed to “header(96),100100101”.

According to an embodiment, at 126, the column partition manager identifies an existing container within the delete column partition having a different row identifier. The existing container corresponds to sequence of rows within the table representing values for the same corresponding rowids and with one or more bits set to indicate deletion. The row identifier falls inside a predetermined range of the different row identifier but setting the bit would increase the size of the container beyond the container size limit. So, the column partition manager splits an existing bit string housed in the existing delete container into two different delete containers within the delete column partition: a modified version of the existing delete container having a modified bit string (because the rows represented in the existing delete container changed) and a new delete container that includes part of the previous existing bit string and the bit flag for the row identifier of the row being presently processed for deletion within the partition. In other words, the length or number of rows that any particular delete container within the delete column partition is configurable and when a threshold is reached, the container is split into two containers and the bit flags adjusted accordingly.

At 130, the column partition manager sets a bit flag for the row within the delete column partition to indicate that the row (via the row identifier) is to be deleted from the table.

In some cases, the delete container being modified to set deletion for a row may include run length fields indicating frequency counts within a compressed version of the data for the delete container. In such a case, at 140, the column partition manager can adjust or even remove a run length field in the delete container to reflect the bit settings once a row is deleted from the table in the compressed control information.

In still another situation, at 150, the column partition manager can create run length fields when none existed for a delete container when it is deemed useful for compression. This can occur when processing the bit flag in the delete column partition. This was discussed above as well.

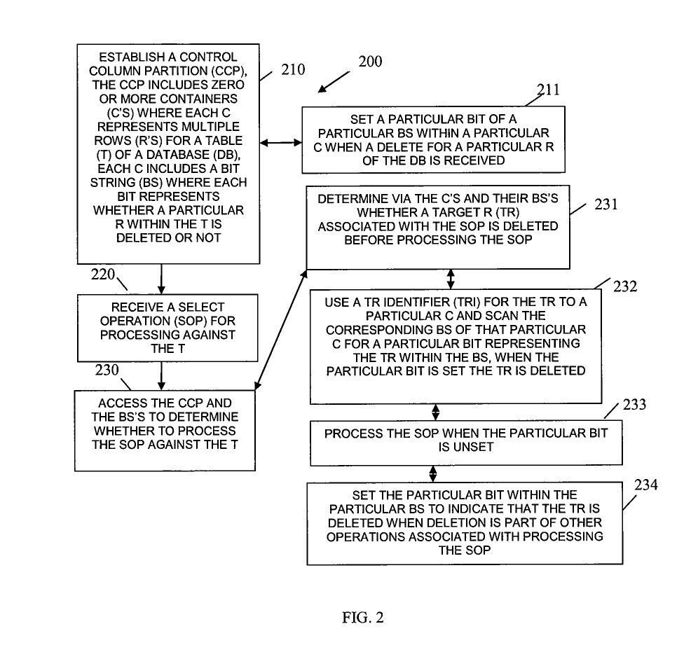

FIG. 2 is a diagram of another method 200 for handling operations on column partitions of a table, according to an example embodiment. The method 200 (hereinafter “partition manager”) is implemented as instructions within a computer-readable storage medium that execute on a plurality of processors, the processors specifically configured to execute the partition manager. Moreover, the partition manager is programmed within a non-transitory computer-readable storage medium. The partition manager may also be operational over a network; the network is wired, wireless, or a combination of wired and wireless.

The partition manager presents another and in some ways an enhanced processing perspective to that which was discussed and shown above with respect to the column partition manager, represented by the method 100 of the FIG. 1.

At 210, the partition manager establishes a control (delete) column partition. The delete column partition includes zero or more delete containers where each container represents multiple rows for a table (with the same row partition, if any) of a database. So, each delete container includes a bit string where each bit in that bit string represents a particular row within the partition that is set for deletion. It is noted that all rows in the table need not be represented in some delete container. That is, the delete containers and their bit strings grow dynamically and as needed, such that initially the delete column partition is empty with no delete containers at all, when a first delete is established for a row in the table, then at least one delete container is dynamically established. When a next row in the table is set for deletion, the delete column partition may still include just a single delete container but adds a bit to represent the new row set for deletion. The details of establishing and dynamically growing the delete column partition were discussed above with reference to the FIG. 1.

According to an embodiment, at 211, the partition manager sets a particular bit of a particular bit string within a particular delete container when a delete for a particular row of the database partition is received. Again, the delete containers and bit strings for any particular container are dynamically managed and grown as needed.

At 220, the partition manager receives a select operation for processing against a table of the database. The select operation can be used in connection with an update and/or a deletion to locate particular rows of the table to take some action on.

At 230, the partition manager accesses the delete column partition and the corresponding bit strings to determine whether to process the select operation for rows in the table. That is, the partition manager can quickly and rapidly access the delete column partition to determine if any rows associated with the select operation are already set for deletion.

So, in an embodiment, at 231, the partition manager determines, via the delete containers and their corresponding bit strings, whether a target row associated with the select operation is set for deletion and, if so, skip over that value for the row in the column partition being scanned.

Continuing with the embodiment of 231 and at 232, the partition manager uses a row identifier for the current value to find a particular delete container and then scans the corresponding bit string of that particular container for a particular bit that corresponds to the row with the current row identifier within the bit string and when the particular bit is set the row is known to be deleted and the value can be skipped.

Continuing with the embodiment of 232 and at 233, the partition manager processes the select operation when the particular bit is unset. In other words, the target row is not set for deletion when the bit is unset so the select operation can continue for the values for the rowid in the various column partitions be accessed.

Still continuing with the embodiment of 233 and at 234, the partition manager sets the particular bit within the particular bit string to indicate that the target row is to be set for deletion as part of other operations associated with processing the select operation. Here, the select operation is deleting the target row of the select operation, so a notation for the proper bit is set to ensure this happens. Alternatively, the rowid for deletion can come from index.

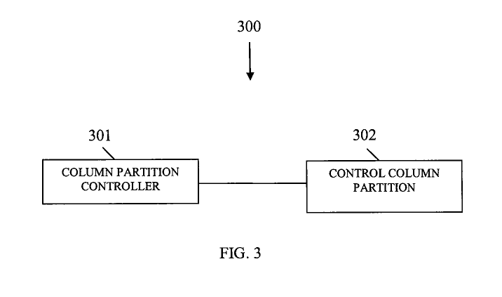

FIG. 3 is a diagram of a column partitioning processing system 400, according to an example embodiment. The column partitioning processing system 400 is implemented, resides, and is programmed within a non-transitory computer-readable storage medium and executes on one or more processors specifically configured to execute the components of the column partitioning processing system 400. Moreover, the column partitioning processing system 400 may be operational over a network and the network is wired, wireless, or a combination of wired and wireless.

The column partitioning processing system 400 implements, inter alia, the techniques presented and described above with reference to the FIGS. 1-2.

The column partitioning processing system 400 includes a column partition controller 401 and a control column partition 402. Each of these and their interactions with one another will now be discussed in turn.

The column partition controller 401 is programmed and implemented within a non-transitory computer-readable storage medium for execution on one or more processors of the network. The one or more processors are specifically configured to process the column partition controller 401. Details of the column partition controller 401 were presented above with respect to the methods 100 and 200 of the FIGS. 1 and 2, respectively.

The column partition controller 401 is configured to represent deletions for multiple rows of a table within zero or more delete containers of the control column partition 402. The details of achieving this were discussed in detail above with reference to the FIGS. 2 and 3.

According to an embodiment, the column partition controller 401 is also configured to split a single delete container when the delete container reaches a predefined threshold size. The split is made into two delete containers where each delete container represents a different set of the multiple rows. Discussions of splitting a delete container and modifying the bit string were presented above with reference to the FIG. 1.

In another situation, the column partition controller 401 is configured to dynamically create the single delete container when a first row is initially set for deletion. That is, initially the control column partition 402 is empty and the column partition controller 401 is configured to dynamically grow delete containers and the contents of the delete containers (bit strings, row identifiers) as needed.

In yet another case, the column partition controller 401 is configured to dynamically grow the bit string when additional rows are deleted corresponding to a delete container. The maximum length of container can be configured up to the maximum size of a data block.

In another situation, the column partition controller 401 is configured to pad the bit string with unset bits when intermediate rows of the multiple rows are not set for deletion. So, each location of the bit string corresponds to a particular row in the table and when a bit string needs to account for intermediate rows in the bit string to get from an existing row set for deletion and a current row set for deletion, the intervening representative bits in the bit string for each intermediate row is padded with unset bits. When there are multiple consecutive 1 bits or 0 bits, run length compression can be used to reduce the size of a container (run length compression would not be used if it doesn't actually reduced the size of the delete container because the run lengths of bits is not long enough to offset adding the run lengths).

The control column partition 402 resides within and is accessible from a non-transitory computer-readable storage medium. The column partition controller 401 creates and manages the control column partition 402. Again, each delete container of the control column partition 402 includes potential representations for multiple rows within the table (or row partition, if any), some of which are set for deletion and some of which are not. The details of creating, using, and managing the control column partition 402 were presented in detail above with reference to the FIGS. 1 and 2.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented and programmed within a non-transitory computer-readable storage medium and processed by a processor, the processor configured to execute the method, comprising:
receiving, via the processor, a row identifier for a row to delete within a table of a database;
ensuring, via the processor, that the row identifier is represented within a control column partition associated with the table; and
setting, via the processor, a bit flag for the row within the control column partition to indicate that the row is deleted from the table.

2. The method of claim 1, wherein receiving further includes identifying the table as being row partitioned and the row is deleted within a row partition of the table and a delete container is one of several delete containers for that row partition.

3. The method of claim 1, wherein ensuring further includes creating a new delete container within the control column partition, the new delete container including the row identifier and the bit flag.

4. The method of claim 1, wherein ensuring further includes identifying an existing delete container within the control column partition having a different row identifier, the existing delete container representing an existing row within the table previously set for deletion, and the row identifier is within a predetermined range of the different row identifier and adding the bit flag to an existing bit string for the existing container to represent the row, a location for the bit flag within the existing bit string identifying the row.

5. The method of claim 4, wherein ensuring further includes padding the existing bit string with unset values beginning at an offset location representing the existing row and including one of the unset values for each intermediate row that exists between the existing row and the row.

6. The method of claim 5, wherein padding further includes prefixing the unset values to the existing bit string when the row precedes the existing row within the table.

7. The method of claim 6, wherein padding further includes appending the unset values to the existing bit string when the row follows the existing row within the partition.

8. The method of claim 1, wherein ensuring further includes identifying an existing delete container within the control column partition having a different row identifier, the existing delete container includes representing an existing row within the table previously set for deletion, and setting the bit for the row to be deleted causes the delete container to exceed the maximum container size and splitting an existing bit string associated with the existing delete container into two different containers having the existing container with a modified bit string and a new container including part of the existing bit string with the bit flag representing the row set for deletion.

9. The method of claim 1 further comprising, adjusting, adding, or removing, via the processor, run length fields for a delete container to reflect frequency counts in a compressed version of the data for the delete container when the row is deleted for the table.

10. The method of claim 1 further comprising, creating, via the processor, run length fields for the delete container associated with the row to reflect frequency counts in a compressed version of the delete container when no run length field existed and still useful when the row is deleted for the table.

11. A method implemented and programmed within a non-transitory computer-readable storage medium and processed by a processor, the processor configured to execute the method, comprising:
establishing, via the processor, a control column partition, the control column partition includes zero or more delete containers where each container represents multiple rows for a table of a database, each single delete container including a bit string where each bit represents a particular row within the table that is set for deletion;
receiving, via the processor, a select operation for processing against the partition; and
accessing, via the processor, delete containers of the control column partition and the bit strings to determine whether to process the select operation against a row of the table.

12. The method of claim 11, wherein establishing further includes setting a particular bit of a particular bit string within a particular single delete container when a delete for a particular row of the table is received.

13. The method of claim 11, wherein accessing further includes determining via the delete containers and their bit strings whether a target row associated with the select operation is set for deletion before processing the select operation.

14. The method of claim 13, wherein accessing further includes using a target row identifier for the target row to access a particular single delete container and scanning the corresponding bit string of that particular single delete container for a particular bit representing the target row within the bit string, when the particular bit is set the target row is set for deletion.

15. The method of claim 14, wherein using further includes processing the select operation when the particular bit is unset.

16. The method of claim 15, wherein processing further includes setting the particular bit within the particular bit string to indicate that the target row is to be set for deletion as part of other operations associated with processing the select operation.

17. A processor-implemented system, comprising:
a column partition controller programmed within a non-transitory computer-readable medium and to execute on a processor; and
a control column partition residing within and accessible from a non-transitory computer-readable medium;
the column partition controller configured to represent deletions for multiple rows of a table within a single delete container of the control column partition, each row within the single delete container identified via a single bit flag in a bit string and each single bit flag is set when the row to which it relates is deleted.

18. The system of claim 17, wherein the column partition controller is configured to split a single delete container when the delete container reaches a predefined maximum size into two delete containers, each delete container representing a different set of the multiple rows.

19. The system of claim 18, wherein the column partition controller is configured to dynamically create a single delete container when a first row is initially set for deletion.

20. The system of claim 17, wherein the column partition controller is configured to dynamically grow the bit string when additional bits set for rows are added to a single delete container.

21. The system of claim 17, wherein the column partition controller is configured to pad the bit string with unset bits when intermediate rows of the multiple rows are not set for deletion.
